(19) United States
(12) Patent Application Publication
(10) Pub. No.: US 2008/0270378 A1
(43) Pub. Date: Oct. 30, 2008

(54) Method, Apparatus and Computer Program Product for Determining Relevance and/or Ambiguity in a Search System

(75) Inventors: Vidya Setlur, Cupertino, CA (US); Jiang Gao, Sunnyvale, CA (US); Erika Reponen, Tampere (FI); Kari Pulli, Palo Alto, CA (US); C. Philipp Schloter, San Francisco, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/769,951

(22) Filed: Jun. 28, 2007

Related U.S. Application Data
(60) Provisional application No. 60/913,716, filed on Apr. 24, 2007.

(51) Int. Cl. G06F 17/30

(52) U.S. Cl. 707/5; 707/E17.108

(57) ABSTRACT

An apparatus for a determining relevance and/or ambiguity in a search system may include a processing element configured for receiving visual media comprising a query, determining search results including a matching score for at least one candidate visual media with respect to the query based on ambiguity and relevance, utilizing a mapping function to provide a confidence level associated with the search results, and providing a visualization of the search results based on the confidence level.

### CROSS REFERENCE TO RELATED APPLICATION

This application claims the benefit of U.S. Provisional Application No. 60/913,716, filed Apr. 24, 2007, the contents of which are incorporated herein in their entirety.

### TECHNOLOGICAL FIELD

Embodiments of the present invention relate generally to content retrieval technology and, more particularly, relate to a method, apparatus and computer program product for determining relevance and/or ambiguity in a search system.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase the ease of information transfer and convenience to users relates to provision of information retrieval in networks. For example, information such as audio, video, image content, text, data, etc., may be made available for retrieval between different entities using various communication networks. Accordingly, devices associated with each of the different entities may be placed in communication with each other to locate and affect a transfer of the information.

Text based searches typically involve the use of a search engine that is configured to retrieve results based on query terms inputted by a user. However, due to linguistic challenges such as words having multiple meanings, the quality of search results may not be consistently high. Additionally, data sources searched may not have information on a particular topic for which the search is being conducted. As such, other search types have been popularized. Recently, content based searches are becoming more popular with respect to visual searching. In certain situations, for example, when a user wishes to retrieve image content from a particular location such as a database, the user may wish to review images based on their content. In this regard, for example, the user may wish to review images of cats, animals, cars, etc. Although some mechanisms have been provided by which metadata may be associated with content items to enable a search for content based on the metadata, insertion of such metadata may be time consuming. Additionally, a user may wish to find content in a database in which the use of metadata is incomplete or unreliable. Accordingly, content based image retrieval solutions have been developed which utilize, for example, a classifier such as a support vector machine (SVM) to classify content based on its relevance with respect to a particular query. Thus, for example, if a user desires to search a database for images of cats, a query image could be provided of a cat and the SVM could search through the database and provide images to the user based on their relevance with respect to the features of the query image.

However, content based image retrieval often classifies images based on low-level features such as color, shape, texture, etc. Accordingly, the boundary between relevance and irrelevance may not be highly refined. In an effort to improve content based image retrieval performance, the concept of relevance feedback was developed. Relevance feedback relates to providing feedback to the classifier regarding images presented as to the relevance of the images. The assumption is that given the relevance feedback, the classifier may better learn the classification boundary between relevant and irrelevant images.

Visual search functions such as, for example, mobile visual search functions performed on a mobile terminal, may leverage large visual databases using image matching to compare a query or input image with images in the visual databases. Image matching may tell how close the input image is to images in the visual database. The top matches (e.g., the most relevant images) may then be presented to the user by being visualized on a display of the mobile terminal. In some cases, context information associated with images may also be presented. Accordingly, simply by pointing a camera mounted on the mobile terminal toward a particular object, the user can get context information associated with the particular object.

Given the potential for obtaining context information related to objects captured within an image in the user's environment, an appreciation may be gained for the importance of determining image matches for meaningful performance and user experience. Several factors such as different viewing angles, motion blur, lighting, similarity between visual objects, angle of capture, zoom level, camera quality, etc., may play a role in image matching and therefore, directly affect quality in matching results.

Accordingly, it may be advantageous to provide an improved method of determining image matches.

### BRIEF SUMMARY

A method, apparatus and computer program product are therefore provided to determine relevance and ambiguity in a search system such as a visual search system. In particular, a method, apparatus and computer program product are provided that provide a mapping function for use in obtaining confidence level information regarding relevance and/or ambiguity measures in image retrieval. Relevance and/or ambiguity measures obtained may then be utilized for visualization of an output of the mapping function in a way that is useful to the user. Accordingly, the efficiency of image content retrieval may be increased and content management, navigation, tourism, and entertainment functions for electronic devices such as mobile terminals may be improved.

In one exemplary embodiment, a method of determining relevance and ambiguity in a search system is provided. The method may include receiving visual media comprising a query, determining search results including a matching score for at least one candidate visual media with respect to the query based on ambiguity and relevance, utilizing a mapping function to provide a confidence level associated with the search results, and providing a visualization of the search results based on the confidence level.

In another exemplary embodiment, a computer program product for determining relevance and ambiguity in a search system is provided. The computer program product includes at least one computer-readable storage medium having computer-readable program code portions stored therein. The computer-readable program code portions include first, second, third and fourth executable portions. The first executable portion is for receiving visual media comprising a query. The second executable portion is for determining search results including a matching score for at least one candidate visual media with respect to the query based on ambiguity and relevance. The third executable portion is for utilizing a mapping function to provide a confidence level associated with the search results. The fourth executable portion is for providing a visualization of the search results based on the confidence level.

In another exemplary embodiment, an apparatus for determining relevance and ambiguity in a search system is provided. The apparatus may include a processing element configured for receiving visual media comprising a query, determining search results including a matching score for at least one candidate visual media with respect to the query based on ambiguity and relevance, utilizing a mapping function to provide a confidence level associated with the search results, and providing a visualization of the search results based on the confidence level.

In another exemplary embodiment, an apparatus for determining relevance and ambiguity in a search system is provided. The apparatus includes means for receiving visual media comprising a query, means for determining search results including a matching score for at least one candidate visual media with respect to the query based on ambiguity and relevance, means for utilizing a mapping function to provide a confidence level associated with the search results, and means for providing a visualization of the search results based on the confidence level.

In yet another exemplary embodiment, a method of determining relevance and ambiguity in a search system is provided. The method may include utilizing a mapping function to provide a confidence level associated with search results including a matching score for at least one candidate visual media with respect to visual media comprising a query based on ambiguity and relevance, and providing information for use in a visualization of the search results based on the confidence level.

In still another exemplary embodiment, a computer program product for determining relevance and ambiguity in a search system is provided. The computer program product includes at least one computer-readable storage medium having computer-readable program code portions stored therein. The computer-readable program code portions include first and second executable portions. The first executable portion is for utilizing a mapping function to provide a confidence level associated with search results including a matching score for at least one candidate visual media with respect to visual media comprising a query based on ambiguity and relevance. The second executable portion is for providing information for use in a visualization of the search results based on the confidence level.

In yet another exemplary embodiment, an apparatus for determining relevance and ambiguity in a search system is provided. The apparatus may include a processing element configured for utilizing a mapping function to provide a confidence level associated with search results including a matching score for at least one candidate visual media with respect to visual media comprising a query based on ambiguity and relevance, and providing information for use in a visualization of the search results based on the confidence level.

Embodiments of the invention may provide a method, apparatus and computer program product for employment in devices to enhance content retrieval such as image content retrieval or retrieval of other visual media (e.g., video). As a result, for example, mobile terminals and other electronic devices may benefit from an ability to perform content retrieval in an efficient manner and provide results to the user in an intelligible and useful manner.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of an apparatus for determining relevance and/or ambiguity in a search system according to an exemplary embodiment of the present invention;

FIG. 4 illustrates an implementation of a mapping function for relevance and ambiguity determination based on individual image matching scores according to an exemplary embodiment of the present invention;

FIG. 5 illustrates another implementation of a mapping function for relevance and ambiguity determination based on a set of image matching scores according to an exemplary embodiment of the present invention;

FIG. 6 illustrates another implementation of a mapping function for relevance and ambiguity determination based on a set of image matching scores and internal linkage analysis of visual objects according to an exemplary embodiment of the present invention;

FIG. 7 illustrates another implementation of a mapping function for relevance and ambiguity determination based on individual or a set of image matching scores in conjunction with information regarding a popularity of visual objects according to an exemplary embodiment of the present invention;

FIG. 8 illustrates a visualization of search results associated with an exact match according to an exemplary embodiment of the present invention;

FIG. 9 illustrates a visualization of search results associated with a close match according to an exemplary embodiment of the present invention;

FIG. 10 illustrates a visualization of search results associated with a plurality of returns according to an exemplary embodiment of the present invention;

FIG. 11 illustrates a visualization of search results associated with an inability to find a match according to an exemplary embodiment of the present invention;

FIG. 12 is a flowchart according to an exemplary method for determining relevance and ambiguity in a search system according to an exemplary embodiment of the present invention; and

FIG. 13 illustrates examples of images for which image ambiguity may be encountered.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

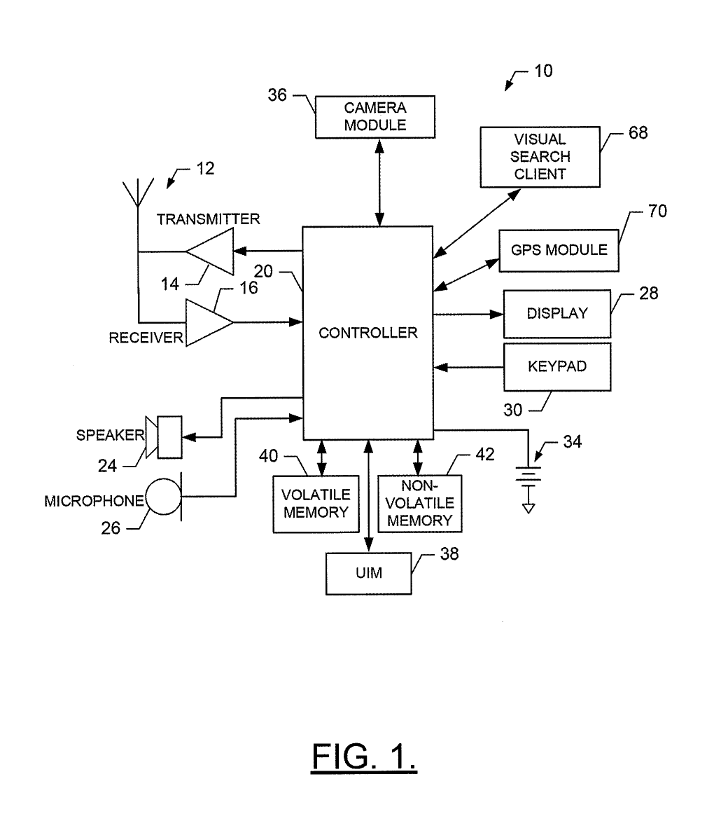

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, GPS devices and other types of voice and text communications systems, can readily employ embodiments of the present invention. Furthermore, devices that are not mobile may also readily employ embodiments of the present invention.

The system and method of embodiments of the present invention will be primarily described below in conjunction with mobile communications applications. However, it should be understood that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols or the like.

It is understood that the controller 20 includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

In an exemplary embodiment, the mobile terminal 10 includes a media capturing element, such as a camera, video and/or audio module, in communication with the controller 20. The media capturing element may be any means for capturing an image, video and/or audio for storage, display or transmission. For example, in an exemplary embodiment in which the media capturing element is a camera module 36, the camera module 36 may include a digital camera capable of forming a digital image file from a captured image. As such, the camera module 36 includes all hardware, such as a lens or other optical component(s), and software necessary for creating a digital image file from a captured image. Alternatively, the camera module 36 may include only the hardware needed to view an image, while a memory device of the mobile terminal 10 stores instructions for execution by the controller 20 in the form of software necessary to create a digital image file from a captured image. In an exemplary embodiment, the camera module 36 may further include a processing element such as a co-processor which assists the controller 20 in processing image data and an encoder and/or decoder for compressing and/or decompressing image data. The encoder and/or decoder may encode and/or decode according to a JPEG standard format. Additionally, or alternatively, the camera module 36 may include one or more views such as, for example, a first person camera view and a third person map view.

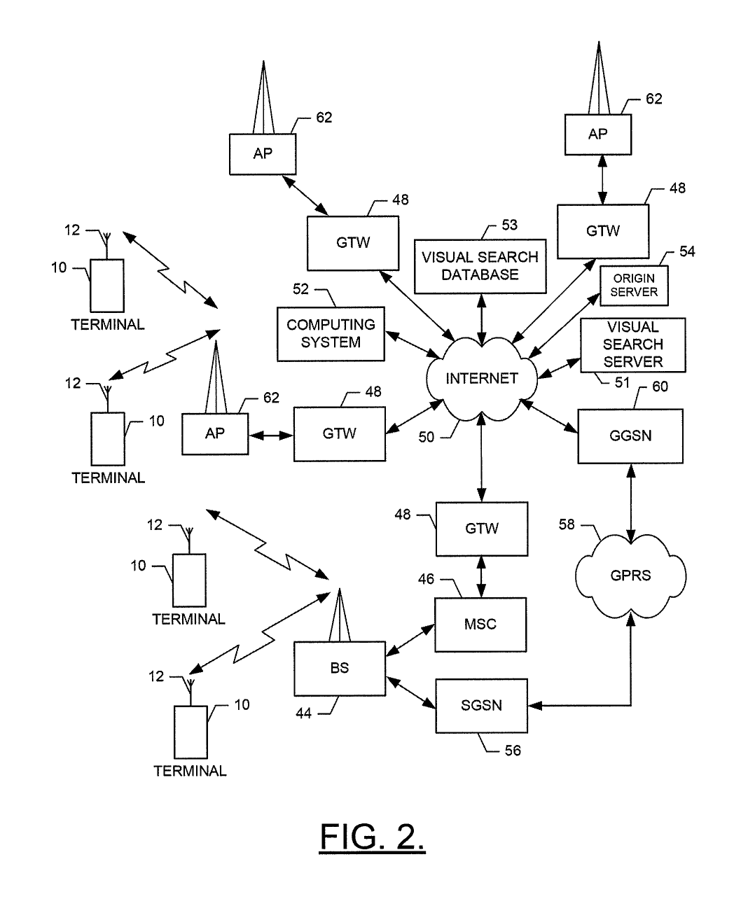

The mobile terminal 10 may further include a positioning sensor such as, for example, GPS module 70 in communication with the controller 20. The positioning sensor may be any means for locating the position of the mobile terminal 10. Additionally, the positioning sensor may be any means for locating the position of a point-of-interest (POI), in images captured by the camera module 36, such as for example, shops, bookstores, restaurants, coffee shops, department stores and other businesses and the like. As such, points-of-interest as used herein may include any entity of interest to a user, such as products and other objects and the like. The positioning sensor may include all hardware for locating the position of a mobile terminal or a POI in an image. Alternatively or additionally, the positioning sensor may utilize a memory device of the mobile terminal 10 to store instructions for execution by the controller 20 in the form of software necessary to determine the position of the mobile terminal or an image of a POI. Additionally, the positioning sensor may be capable of utilizing the controller 20 to transmit/receive, via the transmitter 14/receiver 16, locational information such as the position of the mobile terminal 10 and a position of one or more POIs to a server such as, for example, a visual search server 51 and/or a visual search database 53 (see FIG. 2), described more fully below.

The mobile terminal may also include a visual search client 68 (e.g., a unified mobile visual search/mapping client). The visual search client 68 may be any means or device embodied in hardware, software, or a combination of hardware and software that is capable of communication with the visual search server 51 and/or the visual search database 53 (see FIG. 2) to process a query (e.g., an image or video clip) received from the camera module 36 for providing results including images having a degree of similarity to the query. For example, the visual search client 68 may be configured for recognizing (either through conducting a visual search based on the query image for similar images within the visual search database 53 or through communicating the query image to the visual search server 51 for conducting the visual search and receiving results) objects and/or points-of-interest when the mobile terminal 10 is pointed at the objects and/or POIs or when the objects and/or POIs are in the line of sight of the camera module 36 or when the objects and/or POIs are captured in an image by the camera module 36.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52, origin server 54, the visual search server 51, the visual search database 53, and/or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, visual search server 51, visual search database 53, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

As will be appreciated, by directly or indirectly connecting the mobile terminals 10 and the computing system 52, the origin server 54, the visual search server 51, the visual search database 53 and/or any of a number of other devices, to the Internet 50, the mobile terminals 10 can communicate with one another, the computing system, 52, the origin server 54, the visual search server 51, the visual search database 53, etc., to thereby carry out various functions of the mobile terminals 10, such as to transmit data, content or the like to, and/or receive content, data or the like from, the computing system 52, the origin server 54, the visual search server 51, and/or the visual search database 53, etc. The visual search server 51, for example, may be embodied as one or more other servers such as, for example, a visual map server that may provide map data relating to a geographical area of one or more mobile terminals 10 or one or more points-of-interest (POI) or a POI server that may store data regarding the geographic location of one or more POI and may store data pertaining to various points-of-interest including but not limited to location of a POI, category of a POI, (e.g., coffee shops or restaurants, sporting venue, concerts, etc.) product information relative to a POI, and the like. Accordingly, for example, the mobile terminal 10 may capture an image or video clip which may be transmitted as a query to the visual search server 51 for use in comparison with images or video clips stored in the visual search database 53. As such, the visual search server 51 may perform comparisons with images or video clips taken by the camera module 36 and determine whether or to what degree these images or video clips are similar to images or video clips stored in the visual search database 53.

Although not shown in FIG. 2, in addition to or in lieu of coupling the mobile terminal 10 to computing systems 52 and/or the visual search server 51 and visual search database 53 across the Internet 50, the mobile terminal 10 and computing system 52 and/or the visual search server 51 and visual search database 53 may be coupled to one another and communicate in accordance with, for example, RF, BT, IrDA or any of a number of different wireline or wireless communication techniques, including LAN, WLAN, WiMAX, UWB techniques and/or the like. One or more of the computing system 52, the visual search server 51 and visual search database 53 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing system 52, the visual search server 51 and the visual search database 53, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX, UWB techniques and/or the like.

In an exemplary embodiment, content such as image content may be communicated over the system of FIG. 2 between a mobile terminal, which may be similar to the mobile terminal 10 of FIG. 1 and a network device of the system of FIG. 2, or between mobile terminals. For example, a database may store the content at a network device of the system of FIG. 2, and the mobile terminal 10 may desire to search the content for a particular type of content. However, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, or may be resident on a network device or other device accessible to the communication device.

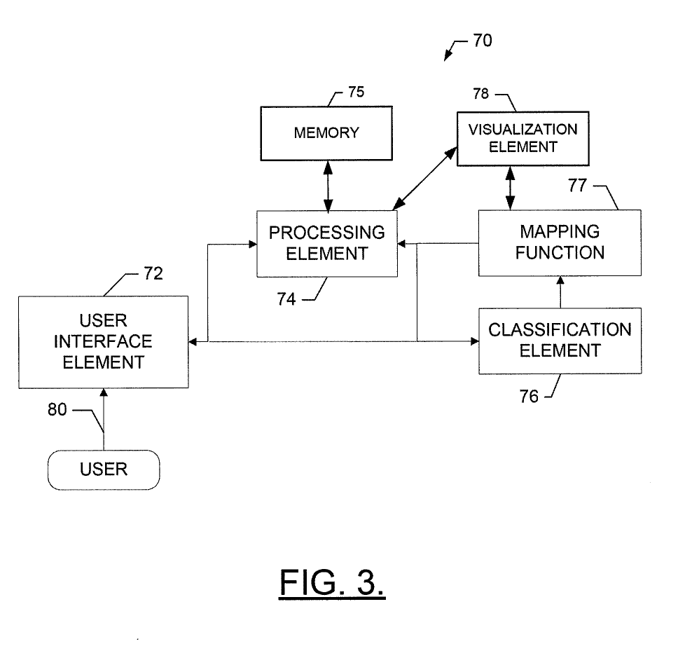

FIG. 3 illustrates a block diagram of an apparatus for determining relevance and/or ambiguity in a search system according to an exemplary embodiment of the present invention. The system of FIG. 3 will be described, for purposes of example, in connection with the mobile terminal 10 of FIG. 1. However, it should be noted that the apparatus of FIG. 3 may also be employed in connection with a variety of other devices, both mobile and fixed, and therefore, embodiments of the present invention should not be limited to application on devices such as the mobile terminal 10 of FIG. 1. In fact, embodiments may also be practiced in the context of a client-server relationship in which the client (e.g., the visual search client 68) issues a query to the server (e.g., the visual search server 51) and the server practices embodiments of the present invention and communicates results to the client. It should also be noted, that while FIG. 3 illustrates one example of a configuration of an apparatus for providing relevance and/or ambiguity information related to a visual search, numerous other configurations may also be used to implement embodiments of the present invention.

Referring now to FIG. 3, a search apparatus 70 for determining relevance and/or ambiguity in a search system is provided. In exemplary embodiments, the search apparatus 70 may be embodied at either one or both of the mobile terminal 10 and the visual search server 51. In other words, portions of the search apparatus 70 may be resident at the mobile terminal 10 while other portions are resident at the visual search server 51. Alternatively, the search apparatus 70 may be resident entirely on the mobile terminal 10 and/or the visual search server 51. The search apparatus 70 may include a user interface element 72, a processing element 74, a memory 75 (which may be a volatile or nonvolatile memory), a classification element 76, a mapping function 77, and a visualization element 78. In an exemplary embodiment, the processing element 74 could be embodied as the controller 20 of the mobile terminal 10 of FIG. 1 or as a processor or controller of the visual search server 51. However, alternatively, the processing element 74 could be a processing element of a different device. Processing elements as described herein may be embodied in many ways. For example, the processing element 74 may be embodied as a processor, a coprocessor, a controller or various other processing means or devices including integrated circuits such as, for example, an ASIC (application specific integrated circuit).

The user interface element 72 may be any device or means embodied in either hardware, software, or a combination of hardware and software that is capable of receiving user inputs and/or providing an output to the user. The user interface element 72 may include, for example, a keyboard, keypad, function keys, mouse, scrolling device, touch screen, or any other mechanism by which a user may interface with the search apparatus 70. The user interface element 72 may also include a display, speaker or other output mechanism for providing user output to the user. In an exemplary embodiment, rather than including a device for actually receiving the user input and/or providing the user output, the user interface element 72 could be in communication with a device for actually receiving the user input and/or providing the user output. As such, the user interface element 72 may be configured to receive indications of the user input from an input device and/or provide messages for communication to an output device.

In an exemplary embodiment, the user interface element 72 may be configured to receive indications of a query 80 from the user. The query 80 may be, for example, an image containing content providing a basis for a content based image retrieval operation. In this regard, the query 80 may be an image (e.g., a query image) acquired by any method. For example, the query 80 could be an image that was acquired from a database, from a memory of the device providing the query 80, from an image acquired via the camera module 36, etc. In other words, the query 80 could be a previously existing image or a newly created image according to different exemplary embodiments.

The user interface element 72 may also be configured to receive relevance feedback such as image feedback from the user. In this regard, for example, the classification element 76 may initially provide image classification data with respect to a set of images based on the query 80 as described in greater detail below. After provision of the image classification data to the user, the user may be enabled to enter image feedback (e.g., via the user interface element 72) with respect to a selected portion of the set of images. In an exemplary embodiment, the image feedback may provide an input to the classification element 76 for application in re-classifying the set of images. However, in embodiments of the present invention, relevance feedback may not be required and, in some embodiments, may not be solicited or provided.

The classification element 76 may be any device or means embodied in either hardware, software, or a combination of hardware and software that is capable of performing image classification with respect to relevance and/or ambiguity in response to a visual search. In an exemplary embodiment, the classification element 76 may be configured to perform a relevance measure with respect to a query image (e.g., the query 80) and a set of images, such as images within a database (e.g., the visual search database 53), and return a set of relevant images on the basis of correspondence of features of the images in the database to the various features of the query image (e.g., according to which images are most relevant). In this regard, the classification element 76 may be configured to, for example, compare one or multiple features of the query 80 to corresponding features of the set of images to provide a classification in terms of relevance with respect to each of the images within the set of images. As such, the classification element 76 may be configured to assign a relevance score to each image of the set of images based on the relevance of each of the images with respect to the query image. In an exemplary embodiment, the classification element 76 may include a feature extraction element for extracting feature information from an image for use in comparison.

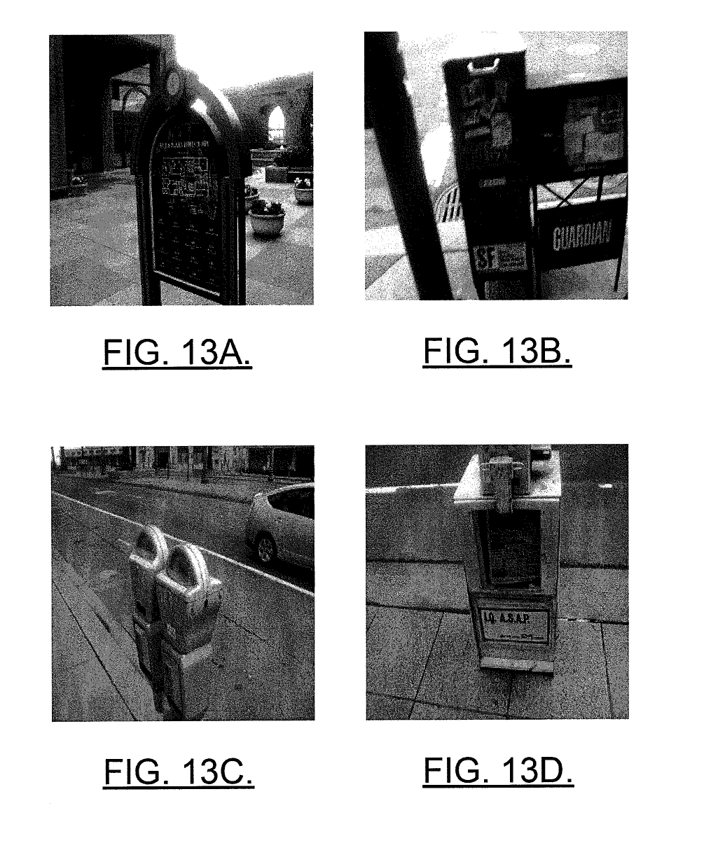

A high relevance score may be achieved merely on the basis of a correspondence between features of the query image and a candidate image. For example, a candidate image including a red car in a grass field taken from a particular angle may have relevance with respect to a query image including a red apple on a green table cloth based on the correspondence of colors between the images. Additionally, another image of an apple in a green background may also be highly relevant. Accordingly, another measure, namely ambiguity, may be an important factor. Ambiguity may be considered as a measure of uncertainty associated with a correspondence between images since, as indicated in the case above, two separate images are both highly relevant. FIG. 13 illustrates examples of image ambiguity with an image search engine. In an exemplary embodiment, the classification element 76 may be further or alternatively configured to perform an ambiguity measure with respect to the query image and the set of images. In this regard, the classification element 76 may be configured to assign an ambiguity score to each image of the set of images based on the ambiguity associated with each of the comparisons.

The classification element 76 may be further configured to determine a matching score for each image in the set of images based on either or both of the relevance and ambiguity scores for each corresponding one of the images. The matching score may be considered as a measure of how similar one image is to another (e.g., how similar a candidate image is to the query image). Accordingly, for example, a very similar image to another image may have high relevancy and low ambiguity. Since, different images may include different objects, matching scores may be quite different. As such, it may be difficult to provide matching scores that are linearly correlated to relevance and at the same time show a clear difference in matching scores when a same input image is matched to two images with different objects. Accordingly, the mapping function 77 may be employed.

The mapping function 77 may be, for example, a function embodied in an algorithm or computational device. In this regard, the mapping function 77 may be embodied as hardware, software or a combination of hardware and software that is configured to determine a confidence level based on the matching scores (e.g., the relevance and ambiguity scores) determined by the classification element 76. In this regard, the mapping function 77 may be configured to combine all factors that contribute to determining relevance and ambiguity for a particular image comparison for determining the confidence level for a candidate image on the basis of comparing the candidate image to the query image.

The visualization element 78 may be any means or device embodied as hardware, software or a combination of hardware and software that is configured to receive confidence level information from the mapping function 77 and visualize (e.g., drive a display) results of the visual search based on the matching scores. For example, the visualization element 78 may be configured to display particular images having matching scores above a particular threshold, having the highest matching scores, or the like. In an exemplary embodiment, the visualization element 78 may be further configured to display such images in a manner that is indicative of a characteristic of the matching score. More precisely, the visualization element 78 may be configured to display such images based on the confidence level information associated with each such image.

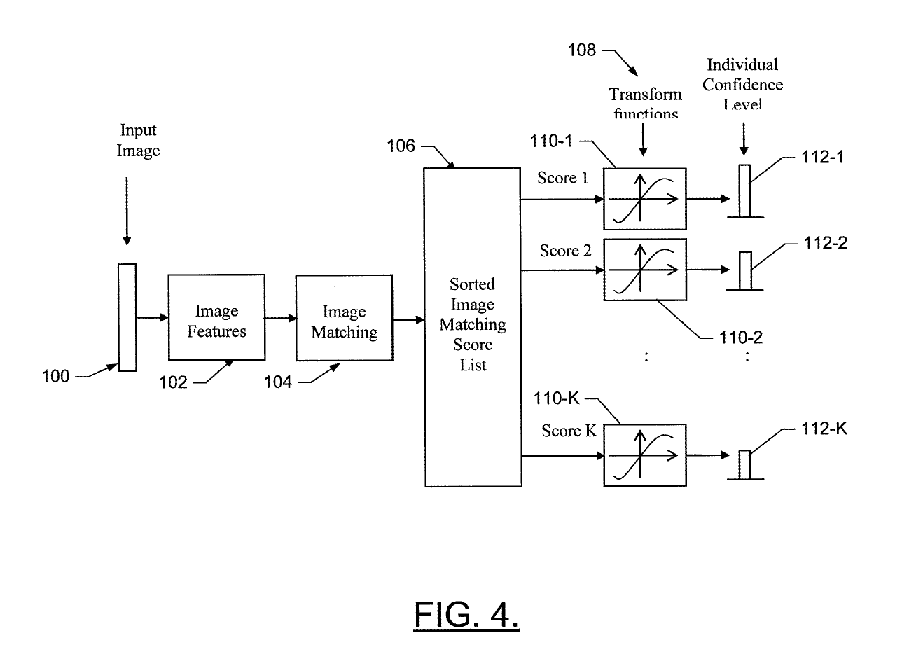

The classification element 76, the mapping function 77, and/or the visualization element 78 may be embodied as or otherwise controlled by the processing element 74. As described above, the mapping function 77 may be configured to determine a confidence level associated with a particular candidate image. However, several different implementations of the mapping function 77 may be employed as illustrated, for example, in FIGS. 4-7. In this regard, FIGS. 4-7 show different exemplary embodiments for implementation of the mapping function 77 in association with determining a confidence level associated with a candidate image.

FIG. 4 illustrates an implementation of the mapping function 77 for relevance and ambiguity determination based on individual image matching scores according to an exemplary embodiment. As shown in FIG. 4, an input image 100 (e.g., a query image) may be input into the classification element 76 and image features may be extracted as indicated at operation 102. Image matching may then be performed at operation 104 on the basis of the extracted features and resulting matching scores for each corresponding feature of candidate images compared to the input image. The matching scores may be sorted or otherwise arranged in a list at operation 106. Each score (e.g., score 1, score 2, . . . , score K) may then be applied to a mapping function at operation 108, which may include a plurality of corresponding transform functions (e.g., transform function 110-1, 110-2, . . . , 110-K) used to map each sorted image matching score to a confidence interval of [0,1] to produce corresponding individual confidence level results (e.g., individual confidence level results 112-1, 112-2, . . . , 112-K) for each image.

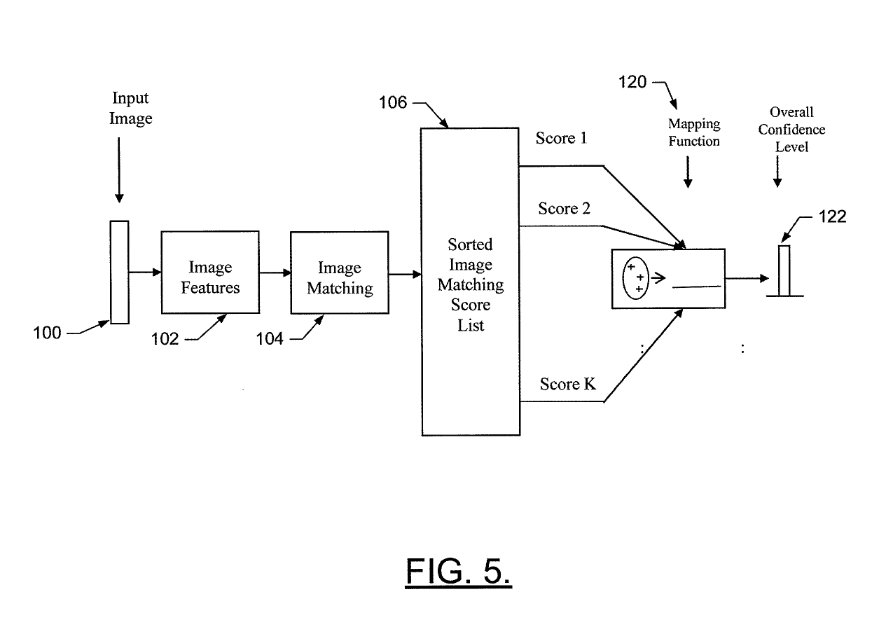

FIG. 5 illustrates another implementation of the mapping function 77 for relevance and ambiguity determination based on a set of image matching scores according to an exemplary embodiment. As shown in FIG. 5, the input image 100 may be input into the classification element 76 and image features may be extracted as indicated at operation 102. Image matching may then be performed at operation 104 on the basis of the extracted features and resulting matching scores for each corresponding feature of candidate images compared to the input image. The matching scores may be sorted or otherwise arranged in a list at operation 106. Each score (e.g., score 1, score 2, . . . , score K) comprising a set of scores may then be applied to a mapping function that is configured to operate on the set of scores to produce a single confidence measure at operation 120. The mapping function according to this exemplary embodiment may be formed by first defining (or training) a general mapping function form with free parameters. The free parameters may be determined based on a real dataset including matching scores and corresponding confidence levels. In other words, the free parameters may be determined based on actual data that has been previously used. Using the determined free parameters, the mapping function may determine a confidence level for a corresponding input matching score (or scores). When a particular search results in several similar matching scores, such situation may be indicative of a high level of ambiguity. Accordingly, by training the mapping function as described above, an improved confidence measure may be produced at operation 122 that matches more closely with user perception.

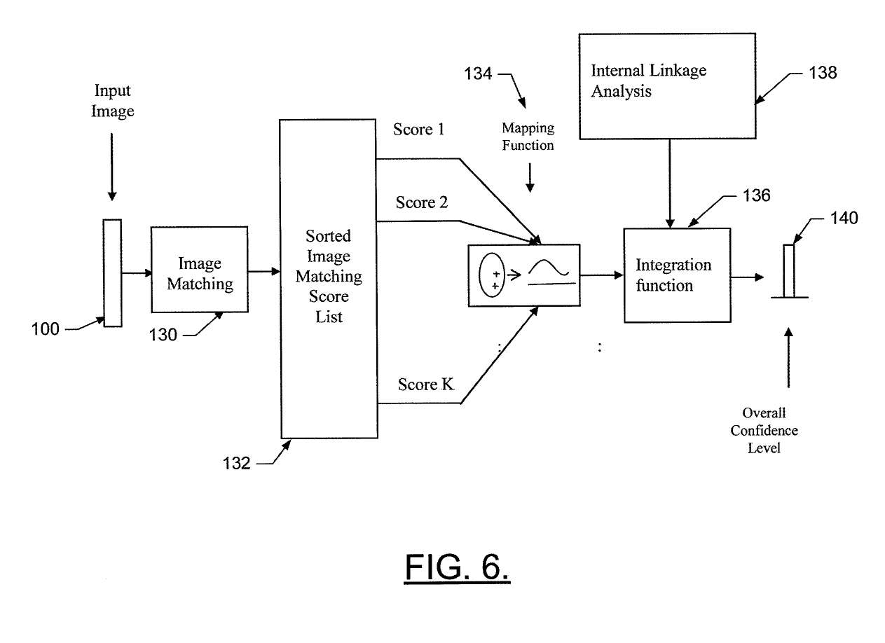

FIG. 6 illustrates another implementation of the mapping function 77 for relevance and ambiguity determination based on a set of image matching scores and internal linkage analysis of visual objects according to an exemplary embodiment. As shown in FIG. 6, the input image 100 may be input into the classification element 76 and image matching may then be performed at operation 130 and resulting matching scores may be determined for each corresponding candidate image compared to the input image. The matching scores may be sorted or otherwise arranged in a list at operation 132. Each score (e.g., score 1, score 2, . . . , score K) comprising a set of scores may then be applied to a mapping function that is configured to operate on the set of scores to produce a single confidence measure at operation 134. The mapping function 77 according to this exemplary embodiment may be trained similar to the mapping function described in the preceding exemplary embodiment. The result from the mapping function may be integrated in an integration function at operation 136 and processed further using internal linkage analysis at operation 138. The integration function may be constructed in a similar manner to the construction of the mapping function described with reference to FIG. 4 above.

In an exemplary embodiment, the internal linkage analysis may provide information on similarities between images which are entries in a particular visual database (e.g., candidate images). For example, a street sign and a sign in a courtyard might look similar and be expected to match well with an input image of a sign. However, this creates ambiguity due to the similarity between the street sign and the sign in the courtyard. Internal linkage analysis may be performed by determining the similarity between each entry in a visual database to provide information on which entries are similar to each other. By using internal linkage analysis a confusion matrix may be created corresponding to each pair of entries in the visual database and confidence level may be determined more precisely at operation 140.

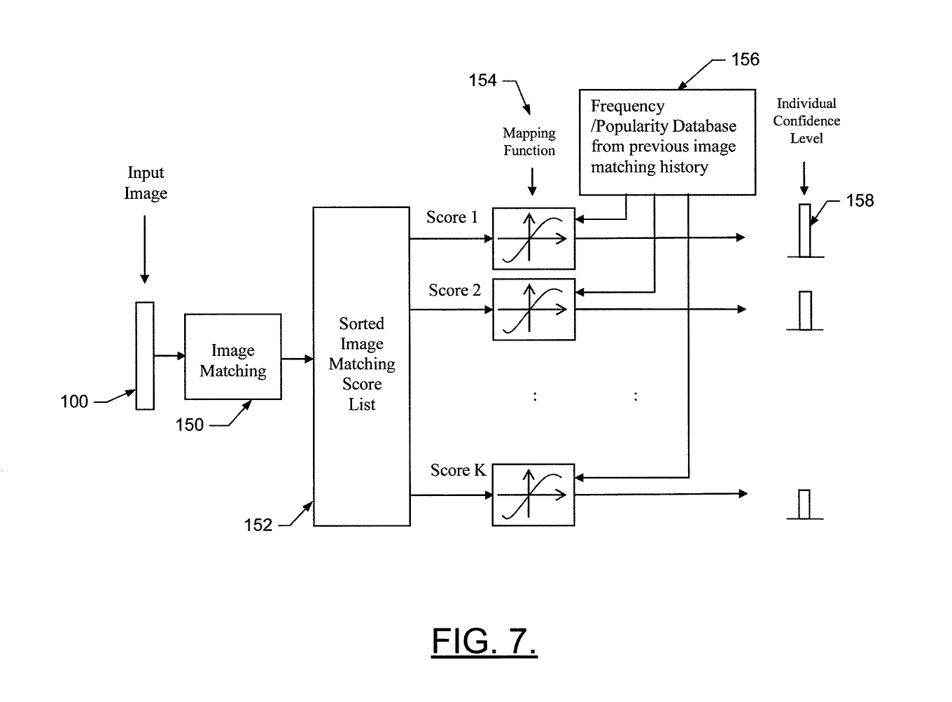

FIG. 7 illustrates another implementation of the mapping function 77 for relevance and ambiguity determination based on individual or a set of image matching scores in conjunction with information regarding a popularity of visual objects according to an exemplary embodiment (although FIG. 7 only illustrates determination based on individual matching scores). Of note, the embodiment of FIG. 7 could also be used in combination with the embodiment of FIG. 6 (e.g., with internal linkage analysis). As shown in FIG. 7, the input image 100 may be input into the classification element 76 and image matching may then be performed at operation 150 on the basis of features of the input image and resulting matching scores for candidate images may be determined. The matching scores may be sorted or otherwise arranged in a list at operation 152. Each score (e.g., score 1, score 2, . . . , score K) may then be applied to a corresponding mapping function that is configured to operate on each of the matching scores at operation 154. However, each corresponding mapping function may receive an input providing frequency or popularity information at operation 156 and individual confidence levels may be produced at operation 158. The information regarding frequency or popularity may be obtained using previous matching history.

The popularity or frequency information may represent a measure of the likelihood that a particular visual object will be matched by a user. For example, if most queries from users are related to the street sign rather than the sign in the courtyard, any ambiguity between the two signs may be resolved in favor of the street sign. Accordingly, adding popularity or frequency as another factor in addition to relevance and ambiguity for returning results responsive to a search may provide even better results with regard to user perception.

As stated above, once a confidence level is generated regarding a candidate image returned in response to a visual search based on a query image, the visualization element 78 may be configured to provide representation of information returned as a result of the visual search in an intuitive manner. In this regard, for example, once the mapping function 77 returns a confidence level for a candidate image, visualization of the returns may be provided based on the confidence level associated with the image match.

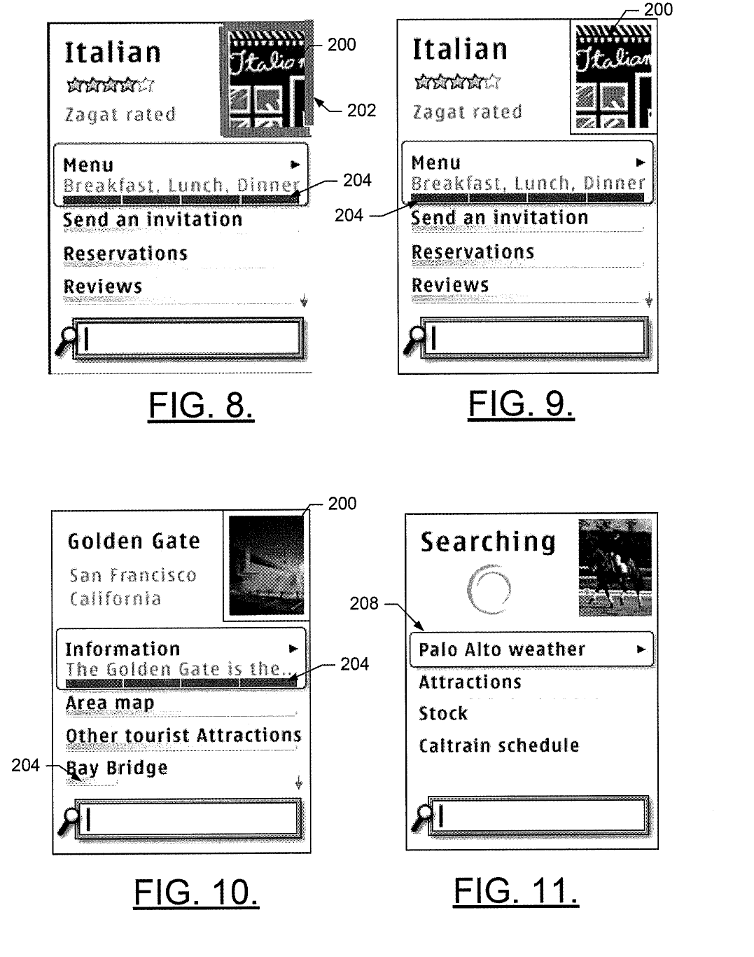

In one exemplary embodiment, as shown in FIG. 8, if there is a confidence level returned with regard to a candidate image 200 that is high, the visualization provided may indicate as much. For example, if an exact match is found, a box 202 may be provided around the image returned to indicate an exact match. The box 202 may be permanent or may flash for a period of time. Additionally or alternatively, a full scale of relevancy indicators 204 may be displayed. The relevancy indicators 204 may be similar to the signal bars users are familiar with in connection with an indication of signal strength. As such, a more full scale of relevancy indicators 204 (e.g., more bars) may be indicative of a higher confidence level. FIG. 9 illustrates an example where a high confidence level is associated with the returned image as indicated by the full scale of the relevancy indicators 204. As can be seen from FIGS. 8 and 9, links related to the returned result may also be displayed.

When a range of confidence levels for a given input image are returned, the user may prefer to be made aware of the various results of the search. Accordingly, for example, as shown in FIG. 10, if the Golden Gate Bridge is mistaken for the Bay Bridge, but the confidence is lower, a result having higher relevancy may be displayed with higher numbers of relevancy indicators illuminated and other options may be displayed in decreasing order of confidence with corresponding lower numbers (or less portions) of relevancy indicators illuminated. When an item is scrolled over, highlighted or selected, an emphasis or a selection window 208 may be placed around the highlighted or selected item.

In one exemplary embodiment, as shown in FIG. 11, if there is ambiguity above a particular threshold or if no match is found, the visualization provided may indicate, for example, “searching” and/or a display of some popular link of interest with no box drawn around the image displayed and no relevancy bars.

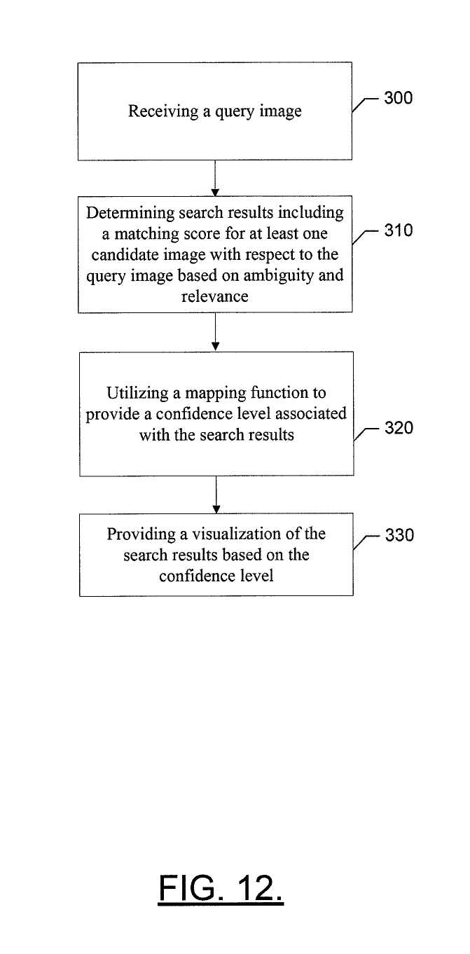

FIG. 12 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal or server and executed by a built-in processor in a mobile terminal or server. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions. It should be noted that while FIG. 12 describes a particular embodiment involving a visual search on the basis of a query image, such a search may be performed for any visual media. As such, candidate visual media may be scored in accordance with embodiments of the present invention as described generally below by way of example, and not limitation.

In this regard, one embodiment of a method of determining relevance and ambiguity for a visual search may include receiving a query image at operation 300 and determining search results including a matching score for at least one candidate image with respect to the query image based on ambiguity and relevance at operation 310. At operation 320, a mapping function may be utilized to provide a confidence level associated with the search results. The method may further include providing a visualization of the search results based on the confidence level at operation 330. In an exemplary embodiment, individual matching scores may be individually mapped using corresponding separate mapping functions. Alternatively, a single mapping function may be used for mapping a plurality of matching scores. In either case, the mapping function may be used in association with internal linkage analysis and/or frequency or popularity information to produce the confidence level.

The above described functions may be carried out in many ways. For example, any suitable means for carrying out each of the functions described above may be employed to carry out embodiments of the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Embodiments of the present invention may be useful, for example, in the context of tourism for context information in mobile tourist information systems in which context information is typically captured as the current location of the user. This context information together with object recognition based on a point of interest database could provide tourists with important information about landmarks. Embodiments of the present invention may help users understand the relevance of a search, for example, if the system confuses the Golden Gate Bridge with the Bay Bridge. Parameters such as location and image feature matching points could be used in our mapping function to determine how relevant the retrieved results are for the landmark and visualize the relevance for the user.

Embodiments of the present invention may also be useful, for example in application for real-time navigation systems that could recognize the objects in the vicinity of the user and retrieve imagery such as GPS maps or other navigational aids to indicate where the user needs to go to as a destination. Other exemplary embodiments could be used in media organization and browser applications. For example, with media capturing devices and their storage capabilities becoming more plentiful, people often capture and store several hundreds of images on their devices or upload images to a image repository. Enabling retrieval of an image that is similar to a query image has immense value, as very often people capture multiple images in the same location that are similar to one another. In addition, if there are hundreds of images that are similar, retrieving one representative image of the similar set may be useful for quick browsing.

Embodiments of the invention may also be useful in connection with entertainment such as movies. For example, an application could be to recognize movie related products such as a DVD cover or a movie poster and to retrieve information such as the storyline, cast, nearby theatres playing the movie, etc.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
receiving visual media comprising a query;
determining search results including a matching score for at least one candidate visual media with respect to the query based on ambiguity and relevance;
utilizing a mapping function to provide a confidence level associated with the search results; and
providing a visualization of the search results based on the confidence level.

2. The method of claim 1, wherein utilizing the mapping function comprises applying a transform function trained using parameters determined from previously used data to determine the confidence level based on a plurality of extracted features of the at least one candidate visual media.

3. The method of claim 1, wherein utilizing the mapping function comprises applying a plurality of trained transform functions, each of which corresponds to a corresponding one of a plurality of features to determine a corresponding confidence level with respect to each of the plurality of features.

4. The method of claim 1, wherein utilizing the mapping function further comprises applying linkage analysis to an output of the mapping function to determine the confidence level.

5. The method of claim 4, wherein applying linkage analysis further comprises applying information defining similarity between visual media of a database from which the at least one candidate visual media is accessed to an integrated output of the mapping function.

6. The method of claim 1, wherein utilizing the mapping function further comprises applying popularity information regarding previous matching operations for the at least one candidate visual media to an output of the mapping function to determine the confidence level.

7. The method of claim 1, wherein providing the visualization comprises providing relevancy indicators to indicate the confidence level.

8. The method of claim 1, wherein providing the visualization comprises providing an indication of an exact match between the query and the candidate visual media.

9. The method of claim 1, wherein providing the visualization comprises providing a different visualization element for each of various different confidence levels.

10. A computer program product comprising at least one computer-readable storage medium having computer-readable program code portions stored therein, the computer-readable program code portions comprising:
a first executable portion for receiving visual media comprising a query;
a second executable portion for determining search results including a matching score for at least one candidate visual media with respect to the query based on ambiguity and relevance;
a third executable portion for utilizing a mapping function to provide a confidence level associated with the search results; and
a fourth executable portion for providing a visualization of the search results based on the confidence level.

11. The computer program product of claim 10, wherein the third executable portion includes instructions for applying a transform function trained using parameters determined from previously used data to determine the confidence level based on a plurality of extracted features of the at least one candidate visual media.

12. The computer program product of claim 10, wherein the third executable portion includes instructions for applying a plurality of trained transform functions, each of which corresponds to a corresponding one of a plurality of features to determine a corresponding confidence level with respect to each of the plurality of features.

13. The computer program product of claim 10, wherein the third executable portion includes instructions for applying linkage analysis to an output of the mapping function to determine the confidence level.

14. The computer program product of claim 13, wherein the third executable portion includes instructions for applying information defining similarity between visual media of a database from which the at least one candidate visual media is accessed to an integrated output of the mapping function.

15. The computer program product of claim 10, wherein the third executable portion includes instructions for applying popularity information regarding previous matching operations for the at least one candidate visual media to an output of the mapping function to determine the confidence level.

16. The computer program product of claim 10, wherein the fourth executable portion includes instructions for providing relevancy indicators to indicate the confidence level.

17. The computer program product of claim 10, wherein the fourth executable portion includes instructions for providing an indication of an exact match between the query and the candidate visual media.

18. The computer program product of claim 10, wherein the fourth executable portion includes instructions for providing a different visualization element for each of various different confidence levels.

19. An apparatus comprising a processing element configured to:
receive visual media comprising a query;
determine search results including a matching score for at least one candidate visual media with respect to the query based on ambiguity and relevance;
utilize a mapping function to provide a confidence level associated with the search results; and
provide a visualization of the search results based on the confidence level.

20. The apparatus of claim 19, wherein the processing element is further configured to apply a transform function trained using parameters determined from previously used data to determine the confidence level based on a plurality of extracted features of the at least one candidate visual media.

21. The apparatus of claim 19, wherein u the processing element is further configured to apply a plurality of trained transform functions, each of which corresponds to a corresponding one of a plurality of features to determine a corresponding confidence level with respect to each of the plurality of features.

22. The apparatus of claim 19, wherein the processing element is further configured to apply linkage analysis to an output of the mapping function to determine the confidence level.

23. The apparatus of claim 22, wherein the processing element is further configured to apply information defining similarity between visual media of a database from which the at least one candidate visual media is accessed to an integrated output of the mapping function.

24. The apparatus of claim 19, wherein the processing element is further configured to apply popularity information regarding previous matching operations for the at least one candidate visual media to an output of the mapping function to determine the confidence level.

25. The apparatus of claim 19, wherein the processing element is further configured to provide relevancy indicators to indicate the confidence level.

26. The apparatus of claim 19, wherein the processing element is further configured to provide an indication of an exact match between the query and the candidate visual media.

27. The apparatus of claim 19, wherein the processing element is further configured to provide a different visualization element for each of various different confidence levels.

28. An apparatus comprising:
means for receiving visual media comprising a query image;
means for determining search results including a matching score for at least one candidate visual media with respect to the query based on ambiguity and relevance;
means for utilizing a mapping function to provide a confidence level associated with the search results; and
means for providing a visualization of the search results based on the confidence level.

29. The apparatus of claim 28, further comprising means for applying linkage analysis to an output of the mapping function to determine the confidence level.

30. The apparatus of claim 28, further comprising means for applying information defining similarity between visual media of a database from which the at least one candidate visual media is accessed to an integrated output of the mapping function.

31. A method comprising:
utilizing a mapping function to provide a confidence level associated with search results including a matching score for at least one candidate visual media with respect to visual media comprising a query based on ambiguity and relevance; and
providing information for use in a visualization of the search results based on the confidence level.

32. A computer program product comprising at least one computer-readable storage medium having computer-readable program code portions stored therein, the computer-readable program code portions comprising:
a first executable portion for utilizing a mapping function to provide a confidence level associated with search results including a matching score for at least one candidate visual media with respect to visual media comprising a query based on ambiguity and relevance; and
a second executable portion for providing information for use in a visualization of the search results based on the confidence level.

33. An apparatus comprising a processing element configured to:
utilize a mapping function to provide a confidence level associated with search results including a matching score for at least one candidate visual media with respect to visual media comprising a query based on ambiguity and relevance; and
provide information for use in a visualization of the search results based on the confidence level.
